(19) United States
(12) Patent Application Publication
(10) Pub. No.: US 2025/0043980 A1
(43) Pub. Date: Feb. 6, 2025

(54) CONTROL METHOD OF AIR CONDITIONER, STORAGE MEDIUM, CONTROL APPARATUS AND AIR CONDITIONER

(71) Applicants: GD MIDEA AIR-CONDITIONING EQUIPMENT CO., LTD., Foshan (CN); MIDEA GROUP CO., LTD., Foshan (CN)

(72) Inventors: Jian YANG, Foshan (CN); Haizhao DENG, Foshan (CN); Xiangqiu LAI, Foshan (CN); Zhichao WANG, Foshan (CN); Ronghua LIAO, Foshan (CN)

(21) Appl. No.: 18/717,604

(22) PCT Filed: Mar. 21, 2022
(86) PCT No.: PCT/CN2022/082082

§ 371 Date: Jun. 7, 2024

(30) Foreign Application Priority Data
Dec. 13, 2021 (CN) 202111519663.0

(51) Int. Cl. F24F 11/64; F24F 11/65; F24F 11/88; F24F 110/10

(52) U.S. Cl. CPC F24F 11/64; F24F 11/65; F24F 11/88; F24F 2110/10

(57) ABSTRACT

A control method includes controlling, in response to an indoor ambient temperature being lower than a first threshold, an air conditioner to enter a high-temperature protection monitoring mode, and controlling, in response to the air conditioner being in the high-temperature protection monitoring mode and the indoor ambient temperature being higher than a second threshold, the air conditioner to enter a high-temperature protection mode, to shut down the air conditioner. The second threshold is higher than the first threshold.

### CROSS-REFERENCE TO RELATED APPLICATION

This application claims priority to Chinese patent application No. 202111519663.0, filed on Dec. 13, 2021 and titled “CONTROL METHOD OF AIR CONDITIONER, STORAGE MEDIUM, CONTROL APPARATUS AND AIR CONDITIONER,” the entire contents of which are incorporated herein by reference.

### FIELD

Embodiments of the present disclosure relate to the technical field of air conditioners, and more particularly, to a control method of an air conditioner, a computer-readable storage medium, a control apparatus, and an air conditioner.

### BACKGROUND

An air conditioner is a widely used temperature control device. However, when the air conditioner fails, the air conditioner may be unable to exchange heat with an ambient environment. In this case, when used in a hot environment, instead of providing a cooling effect, the air conditioner causes a temperature rise in the environment where the air conditioner is located due to the work done by the air conditioner, which wastes energy. Also, the temperature rise is likely to cause discomfort to users and even causes danger, e.g., a tailpipe of the air conditioner is disengaged when moving the air conditioner, which makes it impossible for the air conditioner to exchange heat with an outdoor environment. For example, in hot areas such as the Middle East, if the air conditioner fails to cool effectively yet continues to operate, an indoor ambient temperature may rise above 60° C., which is likely to poses hazardous conditions.

### SUMMARY

The present disclosure aims to solve at least one of the technical problems in the prior art or the related art.

To this end, in a first aspect of the present disclosure, a control method of an air conditioner is provided.

In a second aspect of the present disclosure, a computer-readable storage medium is provided.

In a third aspect of the present disclosure, a control apparatus is provided.

In a fourth aspect of the present disclosure, an air conditioner is provided.

In view of this, in the first aspect, a control method of an air conditioner is provided according to an embodiment of the present disclosure. The method includes: controlling, when an indoor ambient temperature is lower than a first threshold, the air conditioner to enter a high-temperature protection monitoring mode, and when the indoor ambient temperature is higher than a second threshold and the air conditioner is in the high-temperature protection monitoring mode, controlling the air conditioner to enter a high-temperature protection mode, to shut down the air conditioner. The second threshold is higher than the first threshold.

In a possible embodiment, the first threshold is lower than or equal to 45° C. and the second threshold is higher than or equal to 50° C.

In a possible embodiment, the controlling, when the indoor ambient temperature is higher than the second threshold and the air conditioner is in the high-temperature protection monitoring mode, controlling the air conditioner to enter the high-temperature protection mode includes: obtaining, when the indoor ambient temperature is higher than the second threshold and the air conditioner is in the high-temperature protection monitoring mode, a duration of the indoor ambient temperature being higher than the second threshold, and controlling, when the duration being longer than a predetermined duration, the air conditioner to enter the high-temperature protection mode.

In a possible embodiment, the controlling the air conditioner to enter the high-temperature protection mode includes: controlling a compressor of the air conditioner to shut down.

In a possible embodiment, the controlling the air conditioner to enter the high-temperature protection mode further includes: generating alarm information, and controlling the air conditioner to sound an alarm, and transmitting the alarm information to a target terminal matching the air conditioner.

In a possible embodiment, the control method further includes, after the controlling the air conditioner to enter the high-temperature protection mode, to shut down the air conditioner: controlling, when the air conditioner is not in a cooling mode or a dehumidification mode, the air conditioner to exit the high-temperature protection mode, or when the indoor ambient temperature is lower than a third threshold, controlling a compressor of the air conditioner to start up and the air conditioner to exit the high-temperature protection mode. The third threshold is higher than the first threshold and lower than the second threshold.

In a possible embodiment, the air conditioner is a mobile air conditioner. The control method further includes: obtaining a current operation mode of the air conditioner, and controlling, when the current operation mode being a cooling mode or a dehumidification mode and the indoor ambient temperature being lower than the first threshold, the air conditioner to enter the high-temperature protection monitoring mode.

In a possible embodiment, the control method further includes: generating, in response to the air conditioner entering the high-temperature protection mode, tailpipe disengagement information, transmitting the tailpipe disengagement information to a target terminal matched with the air conditioner, and/or controlling the air conditioner to display the tailpipe disengagement information.

In the second aspect, a computer-readable storage medium is provided according to an embodiment of the present disclosure. The computer-readable storage medium stores a computer program. The computer program is used to implement the control method according to any of the above technical solutions.

In the third aspect, a control apparatus is provided according to an embodiment of the present disclosure. The control apparatus includes: a memory having a computer program stored thereon, and a processor configured to execute the computer program. The control method according to any of the above technical solutions is implemented by the processor when executing the computer program.

In the fourth aspect, an air conditioner is provided according to an embodiment of the present disclosure. The air conditioner includes the control apparatus according to the above technical solution.

Compared with the related art, the present disclosure at least provides the following advantageous effects. With the control method of the air conditioner according to the embodiments of the present disclosure, the indoor ambient temperature is collected. When the indoor ambient temperature is lower than the first threshold, the air conditioner is controlled to enter the high-temperature protection monitoring mode. When the indoor ambient temperature is higher than the second threshold in the high-temperature protection monitoring mode, it is indicated that the indoor ambient temperature rises instead of continuously dropping during the operation of the air conditioner. In this case, the air conditioner can be determined to be in an abnormal operation state. As a result, indoor heat energy cannot be normally discharged to an outdoor environment. By controlling the air conditioner to enter the high-temperature protection mode, the air conditioner can be prevented from continuing to operate at a relatively high temperature, which can prevent the indoor ambient temperature from rising due to the operation of the air conditioner, saving energy and avoiding a waste of electric energy. Also, the indoor ambient temperature can be made to approach an ambient temperature, avoiding serious accidents caused by the high indoor ambient temperature.

### BRIEF DESCRIPTION OF THE DRAWINGS

Various other advantages and benefits will become apparent to those skilled in the art through reading the detailed description of preferred embodiments below. The accompanying drawings are merely used for the purpose of illustrating the preferred embodiments, and should not be construed as a limitation on the present disclosure. Moreover, the same components are indicated by the same reference signs throughout the accompanying drawings.

FIG. 1 is a schematic flowchart illustrating a control method of an air conditioner according to an embodiment of the present disclosure;

FIG. 2 is a schematic flowchart illustrating a control method of an air conditioner according to another embodiment of the present disclosure;

FIG. 3 is a block diagram showing a structure of a computer-readable storage medium according to an embodiment of the present disclosure;

FIG. 4 is a block diagram showing a structure of a control apparatus according to an embodiment of the present disclosure;

FIG. 5 is a schematic view showing a structure of an air conditioner according to an embodiment of the present disclosure;

FIG. 6 is a schematic view showing a structure of an air conditioner in another state according to an embodiment of the present disclosure.

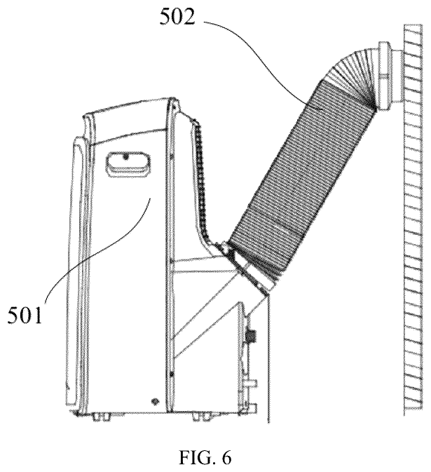

A correspondence between reference signs in FIG. 5 and FIG. 6 and component names is as follows:
501 air conditioner body; 502 tailpipe.

### DETAILED DESCRIPTION OF THE EMBODIMENTS

To better understand the above technical solutions, the technical solutions of the embodiments of the present disclosure are described in detail below with reference to the accompanying drawings and specific embodiments. It should be understood that the embodiments of the present disclosure and specific features in the embodiments are a detailed description of the technical solutions of the embodiments of the present disclosure, rather than limitations on the technical solutions of the present disclosure. The embodiments of the present disclosure and the technical features in the embodiments can be combined with each other without conflict.

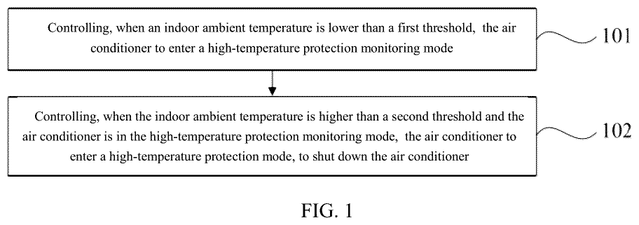

As illustrated in FIG. 1, in a first aspect, a control method of an air conditioner is provided according to an embodiment of the present disclosure. The method includes operations in operations.

In operation 101, when an indoor ambient temperature being lower than a first threshold, the air conditioner is controlled to enter a high-temperature protection monitoring mode. It should be understood that, by setting the first threshold, a time point of the air conditioner to enter the high-temperature protection monitoring mode is identified, which can effectively control a duration for which the air conditioner is in the high-temperature protection monitoring mode, reducing a probability of the air conditioner making an erroneous determination. It should be understood that, the air conditioner can be controlled to enter the high-temperature protection monitoring mode, as long as indoor ambient temperature information is lower than the first threshold. For example, when the indoor ambient temperature is higher than the first threshold at an initial stage of turning on the air conditioner but lower than the first threshold at a predetermined time point, the air conditioner needs to be controlled to enter the high-temperature protection monitoring mode. Similarly, when the indoor ambient temperature information is lower than the first threshold at a time point of turning on the air conditioner, the air conditioner is also controlled to enter the high-temperature protection monitoring mode.

In operation S102, when the indoor ambient temperature is higher than a second threshold and the air conditioner is in the high-temperature protection monitoring mode, the air conditioner is controlled to enter a high-temperature protection mode, to shut down the air conditioner. In the high-temperature protection mode, the indoor ambient temperature being higher than the second threshold indicates a transition of the indoor ambient temperature from lower than the first threshold to higher than the second threshold during the operation of the air conditioner, which indicates that the indoor ambient temperature rises instead of dropping during the operation of the air conditioner. In this case, the air conditioner can be determined to be in an abnormal operation state, with a high likelihood of the air conditioner's tailpipe being disengaged. As a result, indoor heat energy cannot be normally discharged to an outdoor environment. By controlling the air conditioner to enter the high-temperature protection mode, the air conditioner can be prevented from continuing to operate at a relatively high temperature, which can prevent the indoor ambient temperature from rising due to the operation of the air conditioner, saving energy and avoiding a waste of electric energy. Also, the indoor ambient temperature can be made to approach an ambient temperature, avoiding serious accidents caused by the high indoor ambient temperature.

The second threshold is higher than the first threshold, which guarantees that the control method according to the embodiments of the present disclosure can identify a state that the indoor ambient temperature transitions from a low temperature to a high temperature, ensuring that the air conditioner can effectively enter the high-temperature protection mode.

With the control method of the air conditioner according to the embodiments of the present disclosure, the indoor ambient temperature is collected. When the indoor ambient temperature is lower than the first threshold, the air conditioner is controlled to enter the high-temperature protection monitoring mode. When the indoor ambient temperature is higher than the second threshold in the high-temperature protection monitoring mode, it is indicated that the indoor ambient temperature rises instead of continuously dropping during the operation of the air conditioner. In this case, the air conditioner can be determined to be in the abnormal operation state. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

It should be understood that the control method according to the embodiments of the present disclosure is particularly suitable for areas where the ambient temperature is relatively high, such as the Middle East. With the control method according to the embodiments of the present disclosure, the ambient temperature of an environment where the air conditioner is located can be ensured not to rise due to the abnormality or failure of the air conditioner. In the Middle East, the ambient temperature in part of the day can reach above 50° C. With the control method according to the embodiments of the present disclosure, the air conditioner can be controlled to be shut down when in an abnormal state, in such a manner that the indoor ambient temperature is prevented from rising due to the work done by the air conditioner. Therefore, when the air conditioner is in the abnormal state, especially when the tailpipe of the air conditioner is disengaged, the indoor ambient temperature is ensured to approach the ambient temperature, which keeps the indoor ambient temperature from being too high. In this way, protection can be provided to users in the room who are unable to move on their own, such as infants and bedridden patients, to prevent them from becoming dehydrated due to the high temperature.

In some examples, the first threshold is lower than or equal to 45° C., and the second threshold is higher than or equal to 50° C.

When the indoor ambient temperature is lower than 45° C., the air conditioner can be controlled to enter the high-temperature protection monitoring mode. The indoor ambient temperature can be continuously monitored in the high-temperature protection monitoring mode. When the indoor ambient temperature exceeds 50° C., it means that the indoor ambient temperature rises from below 45° C. to 50° C. during the operation of the air conditioner, which indicates that the indoor ambient temperature rises instead of continuously dropping during the operation of the air conditioner. In this case, the air conditioner can be determined to be in the abnormal operation state, with the high likelihood of the air conditioner's tailpipe being disengaged. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

In the embodiments provided by the present disclosure, the first threshold is set to be lower than or equal to 45° C. When the first threshold is higher than 45° C., the air conditioner fails to enter the high-temperature protection monitoring mode in time. Therefore, it is likely that the air conditioner has developed an abnormal condition but has not entered the high-temperature protection monitoring mode.

In the embodiments provided by the present disclosure, the second threshold is higher than or equal to 50° C. When the indoor ambient temperature rises rather than drops, until it exceeds 50° C., the health of the users may be affected if the air conditioner operates continuously. Therefore, the second threshold is set to be higher than or equal to 50° C. In a case where the indoor ambient temperature is lower than 50° C., the indoor ambient temperature has little influence on the users in this case, even though this case may indicate that the air conditioner fails. The rise of the ambient temperature is likely to be caused by an external environment. Therefore, when the indoor ambient temperature is lower than 50° C., the air conditioner cannot be controlled to enter the high-temperature protection mode, to reduce the probability of the air conditioner making the erroneous determination.

In some examples, controlling, when the indoor ambient temperature is higher than the second threshold and the air conditioner is in the high-temperature protection monitoring mode, the air conditioner to enter the high-temperature protection mode includes: obtaining, when the indoor ambient temperature is higher than the second threshold and the air conditioner is in the high-temperature protection monitoring mode, a duration of the indoor ambient temperature being higher than the second threshold, and controlling, when the duration is longer than a predetermined duration, the air conditioner to enter the high-temperature protection mode.

When the indoor ambient temperature is detected to be higher than the second threshold, the duration of the indoor ambient temperature being higher than the second threshold can be measured. When the duration is longer than the predetermined duration, it is indicated that the indoor ambient temperature is above the second threshold for a long period of time. That is, the indoor ambient temperature does not drop due to the operation of the air conditioner for a long period of time. In this case, there is a high probability that the air conditioner is abnormal, with the high likelihood of the air conditioner's tailpipe being disengaged. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

In some examples, the predetermined duration may be higher than or equal to five minutes. When the rise of the indoor ambient temperature is caused by the outdoor ambient temperature, the indoor ambient temperature is unlikely to remain persistently above the second threshold under normal conditions with the continuous operation of the air conditioner. When the duration of the indoor ambient temperature being higher than the second threshold is longer than five minutes, the rise of the indoor ambient temperature is likely to be caused by the failure of the air conditioner. In this case, the air conditioner should be controlled to enter the high-temperature protection mode, to avoid a further rise of the indoor ambient temperature caused by the operation of the air conditioner.

In some examples, controlling the air conditioner to enter the high-temperature protection mode includes: controlling a compressor of the air conditioner to shut down.

The compressor is the most energy-consuming power component of the air conditioner. Controlling the compressor to shut down can reduce the work done by the air conditioner, preventing the heat energy generated by the air conditioner from causing the indoor ambient temperature to rise.

In some examples, controlling the air conditioner to enter the high-temperature protection mode further includes: generating alarm information, and controlling the air conditioner to sound an alarm, and transmitting the alarm information to a target terminal matching the air conditioner.

When the air conditioner enters the high-temperature protection mode, it means that the indoor ambient temperature is high. In this case, the alarm information can be generated. On the one hand, the air conditioner is controlled to sound the alarm to wake up or warn an indoor user, to avoid the user being in a high-temperature environment for a long time, preventing a high temperature from affecting the user's health. On the other hand, the alarm information can also be transmitted to the target terminal. The target terminal may be a terminal communicatively connected to the air conditioner or an application installed in a terminal, for better warning the user, which prevents the user from being in the high-temperature environment for a long time.

It should be understood that, the terminal includes other devices that can receive and display information, such as a mobile phone, a desktop computer, a tablet computer, and a notebook computer.

It should be understood that, the air conditioner can sound an acoustic-optical alarm to warn the user as soon as possible.

The control method according to the embodiments of the present disclosure takes into account that an infant, an elderly person, or a patient who cannot act autonomously may not be in the same space with his/her guardian in some cases. The infant, the elderly person, or the patient is unlikely to leave the high-temperature environment on their own when the ambient temperature is too high. Therefore, transmitting the alarm information to the target terminal can enable the guardian to find the abnormality of the indoor ambient temperature as soon as possible, which is beneficial for the guardian to take the infant, the elderly person, or the patient away from the high-temperature environment as soon as possible and for the guardian to find the abnormality of the air conditioner as soon as possible.

In some examples, the control method further includes, after controlling the air conditioner to enter the high-temperature protection mode, to shut down the air conditioner: controlling, when the air conditioner is not in a cooling mode or a dehumidification mode, the air conditioner to exit the high-temperature protection mode, or controlling, when the indoor ambient temperature is lower than a third threshold, a compressor of the air conditioner to start up and the air conditioner to exit the high-temperature protection mode. The third threshold is higher than the first threshold and lower than the second threshold.

It should be understood that, when the air conditioner is not in the cooling mode or the dehumidification mode, it is unnecessary to consider that the rise of the indoor temperature caused by the work done by the air conditioner causes discomfort to the user. Therefore, the air conditioner can be controlled to exit the high-temperature protection mode in this case to avoid discomfort to the user caused by repeated shutdown of the air conditioner.

When the indoor ambient temperature is lower than the third threshold, it is indicated that the indoor ambient temperature drops below the third threshold from above the second threshold. In this case, fluctuations of the indoor ambient temperature are likely to be caused by the external environment. Therefore, the air conditioner can be controlled to exit the high-temperature protection mode, and the compressor of the air conditioner can be turned on again to enable the air conditioner to operate normally.

In some examples, the control method further includes: obtaining a current operation mode of the air conditioner, and controlling, when the current operation mode is a cooling mode or a dehumidification mode and the indoor ambient temperature is lower than the first threshold, the air conditioner to enter the high-temperature protection monitoring mode.

Controlling, when the operation mode of the air conditioner is the cooling mode or the dehumidification mode, the air conditioner to enter the high-temperature protection mode takes into consideration that the indoor ambient temperature may change from high to low when the air conditioner is in a heating mode. The indoor ambient temperature is compared with the first threshold when the air conditioner is in the cooling mode or the dehumidification mode, which can reduce the probability of the air conditioner making the erroneous determination.

In some examples, the air conditioner may be a mobile air conditioner. The control method further includes: generating, in response to the air conditioner entering the high-temperature protection mode, tailpipe disengagement information, transmitting the tailpipe disengagement information to a target terminal matching the air conditioner, and/or controlling the air conditioner to display the tailpipe disengagement information.

When the air conditioner enters the high-temperature protection mode, it is likely that the air conditioner experiences a failure. The type of the failure is likely to be that the tailpipe is disengaged with the air conditioner. In this case, the tailpipe disengagement information can be generated to prompt the user to deal with the tailpipe. Also, the tailpipe disengagement information can be transmitted to the target terminal, in such a manner that the user can know the abnormality of the air conditioner as soon as possible.

It should be understood that the target terminal may be a terminal communicatively connected to the air conditioner or an application installed in the terminal.

It should be understood that, the terminal includes other devices that can receive and display information, such as a mobile phone, a desktop computer, a tablet computer, and a notebook computer.

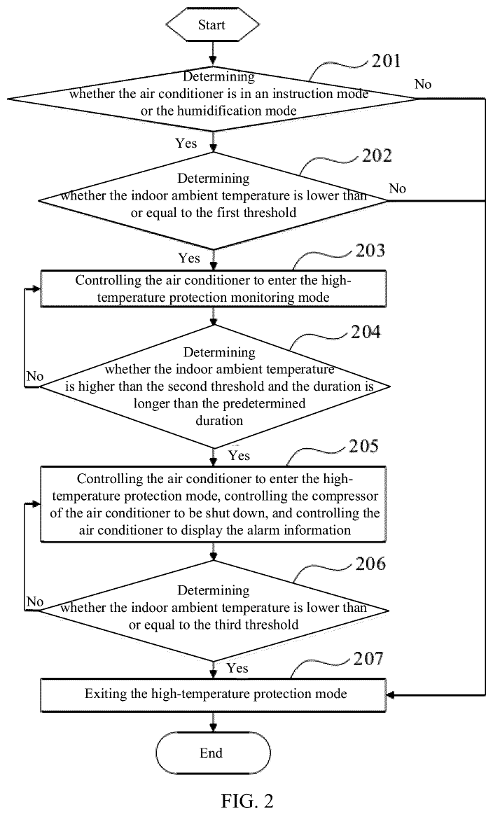

As illustrated in FIG. 2, in some examples, the control method of the air conditioner includes following operations.

In operation 201, whether the air conditioner is in a cooling mode or the humidification mode is determined. When the air conditioner is in the cooling mode or the humidification mode, the operation in operation 202 is executed. Otherwise, the operation in operation 207 is executed.

In operation 202, whether the indoor ambient temperature is lower than or equal to the first threshold is determined. When the indoor ambient temperature is lower than or equal to the first threshold, the operation in operation 203 is executed, otherwise, the operation in operation 207 is executed.

In operation 203, the air conditioner is controlled to enter the high-temperature protection monitoring mode.

In operation 204, whether the indoor ambient temperature is higher than the second threshold and the duration is longer than the predetermined duration are determined. When the indoor ambient temperature is higher than the second threshold and the duration being longer than the predetermined duration, the operation in operation 205 is executed. Otherwise, the operation in operation 203 is executed.

In operation 205, the air conditioner is controlled to enter the high-temperature protection mode, the compressor of the air conditioner is controlled to be shut down, and the air conditioner is controlled to display the alarm information.

In operation 206, whether the indoor ambient temperature is lower than or equal to the third threshold is determined. When the indoor ambient temperature is lower than or equal to the third threshold, the operation in operation 207 is executed. Otherwise, the operation in operation 205 is executed.

In operation 207, the high-temperature protection mode is exited.

With the control method of the air conditioner according to the embodiments of the present disclosure, the indoor ambient temperature is collected. When the indoor ambient temperature is lower than the first threshold, the air conditioner is controlled to enter the high-temperature protection monitoring mode. When the indoor ambient temperature is higher than the second threshold in the high-temperature protection monitoring mode, it is indicated that the indoor ambient temperature rises instead of continuously dropping during the operation of the air conditioner. In this case, the air conditioner can be determined to be in the abnormal operation state. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

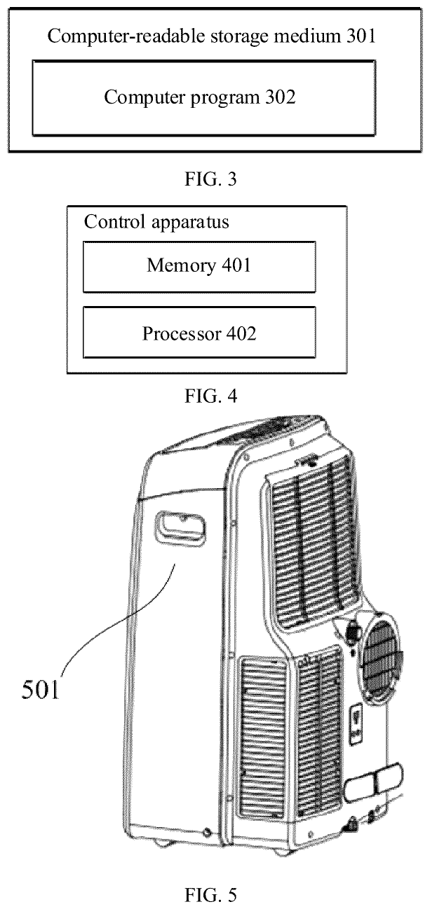

As illustrated in FIG. 3, in a second aspect, a computer-readable storage medium 301 is provided according to an embodiment of the present disclosure. The computer-readable storage medium 301 stores a computer program 302. The computer program 302 is used to implement the control method of any of the above technical solutions.

With the computer-readable storage medium 301 according to the embodiments of the present disclosure, the indoor ambient temperature is collected. When the indoor ambient temperature is lower than the first threshold, the air conditioner is controlled to enter the high-temperature protection monitoring mode. When the indoor ambient temperature is higher than the second threshold in the high-temperature protection monitoring mode, it is indicated that the indoor ambient temperature rises instead of continuously dropping during the operation of the air conditioner. In this case, the air conditioner can be determined to be in the abnormal operation state. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

It should be understood that, by setting the first threshold, the time point of the air conditioner to enter the high-temperature protection monitoring mode is identified, which can effectively control the duration for which the air conditioner is in the high-temperature protection monitoring mode, reducing the probability of the air conditioner making the erroneous determination. It should be understood that, the air conditioner can be controlled to enter the high-temperature protection monitoring mode, as long as the indoor ambient temperature information is lower than the first threshold. For example, when the indoor ambient temperature is higher than the first threshold at the initial stage of turning on the air conditioner but lower than the first threshold at the predetermined time point, the air conditioner needs to be controlled to enter the high-temperature protection monitoring mode. Similarly, when the indoor ambient temperature information is lower than the first threshold at the time point of turning on the air conditioner, the air conditioner is also controlled to enter the high-temperature protection monitoring mode.

In the high-temperature protection mode, the indoor ambient temperature being higher than the second threshold indicates the transition of the indoor ambient temperature from lower than the first threshold to higher than the second threshold during the operation of the air conditioner, which indicates that the indoor ambient temperature rises instead of dropping during the operation of the air conditioner. In this case, the air conditioner can be determined to be in the abnormal operation state, with the high likelihood of the air conditioner's tailpipe being disengaged. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

Based on this understanding, the technical solutions of the present disclosure may be embodied in a form of a software product. The software product may be stored on a non-volatile storage medium (which may be a Compact Disc Read-Only Memory (CD-ROM), a USB flash disk, a removable hard drive, etc.), and include a number of instructions to cause a computing device (which may be a personal computer, a server, or a network device, etc.) to implement a method according to any of the embodiments of the present disclosure.

As illustrated in FIG. 4, in a third aspect, a control apparatus is provided according to an embodiment of the present disclosure. The control apparatus includes: a memory 401 having a computer program stored thereon, and a processor 402 configured to execute a computer program. The control method according to any of the above technical solutions is implemented by the processor 402 when executing the computer program.

With the control apparatus according to the embodiments of the present disclosure, the indoor ambient temperature is collected. When the indoor ambient temperature is lower than the first threshold, the air conditioner is controlled to enter the high-temperature protection monitoring mode. When the indoor ambient temperature is higher than the second threshold in the high-temperature protection monitoring mode, it is indicated that the indoor ambient temperature rises instead of continuously dropping during the operation of the air conditioner. In this case, the air conditioner can be determined to be in the abnormal operation state. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

It should be understood that, by setting the first threshold, the time point of the air conditioner to enter the high-temperature protection monitoring mode is identified, which can effectively control the duration for which the air conditioner is in the high-temperature protection monitoring mode, reducing the probability of the air conditioner making the erroneous determination. It should be understood that, the air conditioner can be controlled to enter the high-temperature protection monitoring mode, as long as the indoor ambient temperature information is lower than the first threshold. For example, when the indoor ambient temperature is higher than the first threshold at the initial stage of turning on the air conditioner but lower than the first threshold at the predetermined time point, the air conditioner needs to be controlled to enter the high-temperature protection monitoring mode. Similarly, when the indoor ambient temperature information is lower than the first threshold at the time point of turning on the air conditioner, the air conditioner is also controlled to enter the high-temperature protection monitoring mode.

In the high-temperature protection mode, the indoor ambient temperature being higher than the second threshold indicates the transition of the indoor ambient temperature from lower than the first threshold to higher than the second threshold during the operation of the air conditioner, which indicates that the indoor ambient temperature rises instead of dropping during the operation of the air conditioner. In this case, the air conditioner can be determined to be in the abnormal operation state, with the high likelihood of the air conditioner's tailpipe being disengaged. As a result, the indoor heat energy cannot be normally discharged to the outdoor environment. By controlling the air conditioner to enter the high-temperature protection mode, the air conditioner can be prevented from continuing to operate at the relatively high temperature, which can prevent the indoor ambient temperature from rising due to the operation of the air conditioner, saving the energy and avoiding the waste of electric energy. Also, the indoor ambient temperature can be made to approach the ambient temperature, avoiding serious accidents caused by the high indoor ambient temperature.

In some examples, the control apparatus may further include a user interface, a network interface, a camera, a Radio Frequency (RF) circuit, a sensor, an audio circuit, a WI-FI module, and the like. The user interface may include a display, an input unit such as a keyboard, etc. In some embodiments, the user interface may further include a USB interface, a card reader interface, etc. In some embodiments, the network interface may include a standard wired interface, a wireless interface (such as a WI-FI interface), etc.

In an exemplary embodiment, the control apparatus may further include an input-output interface and a display device. Respective functional units may communicate with each other through a bus. The memory stores a computer program. A processor is configured to execute the program stored on the memory to implement the method according to any of the above embodiments.

The storage medium may further include an operation system and a network communication module. The operation system is a program for managing hardware and software resources of an entity device for the above-mentioned method, and supports operation of an information processing program and other software and/or programs. The network communication module is configured to realize communication between components in the storage medium and communication with other hardware and software in an information processing entity device.

From the description of the above embodiments, it will be clear to those skilled in the art that the present disclosure can be implemented with the aid of software and a necessary common hardware platform or can be implemented through hardware.

In a fourth aspect, an air conditioner is provided according to an embodiment of the present disclosure. The air conditioner includes the control apparatus according to any of the above technical solutions.

Since the air conditioner according to the embodiments of the present disclosure includes the control apparatus according to any of the above technical solutions, the air conditioner has all the intended effects of the control apparatus according to any of the above technical solutions, and thus details thereof will be omitted here.

As illustrated in FIG. 5 and FIG. 6, in some examples, the air conditioner includes an air conditioner body 501 and a tailpipe 502 connected to the air conditioner body. The tailpipe 502 is configured to be in communication with an outside of a space where the air conditioner is located. The compressor of the air conditioner is arranged in the air conditioner body.

As illustrated in FIG. 5, the air conditioner is in a normal state. The air conditioner can transfer the indoor heat energy to the outside. As illustrated in FIG. 6, the tailpipe 502 of the air conditioner is disengaged, and thus the air conditioner is unable to transfer the indoor heat energy to the outside.

In the present disclosure, terms “first,” “second,” and “third” are only used for descriptive purposes, and cannot be understood as indicating or implying relative importance. The term “plurality” means at least two, unless otherwise specifically defined. Terms such as “mount,” “connect,” “connect to,” and “fix” should be understood in a broad sense. For example, it may be a fixed connection or a detachable connection or connection as one piece, direct connection or indirect connection through an intermediate. For those skilled in the art, specific meanings of the above-mentioned terms in the present disclosure can be understood according to specific circumstances.

In the description of the present disclosure, it should be understood that terms such as “over,” “below,” “left,” “right,” “front,” and “rear” should be construed to refer to the orientation or the position as shown in the drawings, and is only for the convenience of describing the present disclosure and simplifying the description, rather than indicating or implying that the pointed device or unit must have a specific orientation, or be constructed and operated in a specific orientation, and therefore cannot be understood as a limitation of the present disclosure.

Reference throughout this specification to terms such as “an embodiment,” “some embodiments,” and “a specific example,” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

While the embodiments of the present disclosure have been described above, they are not intended to limit the present disclosure. For those skilled in the art, various changes and variations can be made to the present disclosure. Any modifications, equivalent substitutions, and improvements made within the spirit and principle of the present disclosure are to be encompassed by the scope of the present disclosure.

1.-11. (canceled)

12. A control method comprising:
controlling, in response to an indoor ambient temperature being lower than a first threshold, an air conditioner to enter a high-temperature protection monitoring mode; and
controlling, in response to the air conditioner being in the high-temperature protection monitoring mode and the indoor ambient temperature being higher than a second threshold, the air conditioner to enter a high-temperature protection mode, to shut down the air conditioner;
wherein the second threshold is higher than the first threshold.

13. The control method according to claim 12, wherein:
the first threshold is lower than or equal to 45° C.; and
the second threshold is higher than or equal to 50° C.

14. The control method according to claim 12, wherein controlling the air conditioner to enter the high-temperature protection mode includes:
obtaining a duration during which the indoor ambient temperature is higher than the second threshold; and
controlling, in response to the duration being longer than a predetermined duration, the air conditioner to enter the high-temperature protection mode.

15. The control method according to claim 12, wherein controlling the air conditioner to enter the high-temperature protection mode includes:
controlling a compressor of the air conditioner to shut down.

16. The control method according to claim 12, wherein controlling the air conditioner to enter the high-temperature protection mode includes:
generating alarm information, and controlling the air conditioner to sound an alarm; and
transmitting the alarm information to a target terminal matched with the air conditioner.

17. The control method according to claim 12, further comprising, after controlling the air conditioner to enter the high-temperature protection mode to shut down the air conditioner:
controlling, in response to the air conditioner being not in a cooling mode or a dehumidification mode, the air conditioner to exit the high-temperature protection mode.

18. The control method according to claim 12, further comprising, after controlling the air conditioner to enter the high-temperature protection mode to shut down the air conditioner:
controlling, in response to the indoor ambient temperature being lower than a third threshold, a compressor of the air conditioner to start and the air conditioner to exit the high-temperature protection mode;
wherein the third threshold is higher than the first threshold and lower than the second threshold.

19. The control method according to claim 12, further comprising:
obtaining a current operation mode of the air conditioner; and
controlling, in response to the current operation mode being a cooling mode or a dehumidification mode and the indoor ambient temperature being lower than the first threshold, the air conditioner to enter the high-temperature protection monitoring mode.

20. The control method according to claim 12, further comprising:
generating, in response to the air conditioner entering the high-temperature protection mode, tailpipe disengagement information;
performing at least one of:
transmitting the tailpipe disengagement information to a target terminal matched with the air conditioner; or
controlling the air conditioner to display the tailpipe disengagement information.

21. A non-transitory computer-readable storage medium storing one or more computer programs that, when executed by one or more processors, cause the one or more processors to implement the control method according to claim 12.

22. A control apparatus comprising:
one or more memories storing one or more computer programs; and
one or more processors configured to execute the one or more computer programs to:
control, in response to an indoor ambient temperature being lower than a first threshold, an air conditioner to enter a high-temperature protection monitoring mode; and
control, in response to the air conditioner being in the high-temperature protection monitoring mode and the indoor ambient temperature being higher than a second threshold, the air conditioner to enter a high-temperature protection mode, to shut down the air conditioner;
wherein the second threshold is higher than the first threshold.

23. The control terminal according to claim 22, wherein:
the first threshold is lower than or equal to 45° C.; and
the second threshold is higher than or equal to 50° C.

24. The control terminal according to claim 22, wherein the one or more programs, when executed by the one or more processors, further cause the one or more processors to:
obtain a duration during which the indoor ambient temperature is higher than the second threshold; and
control, in response to the duration being longer than a predetermined duration, the air conditioner to enter the high-temperature protection mode.

25. The control terminal according to claim 22, wherein the one or more programs, when executed by the one or more processors, further cause the one or more processors to:
control a compressor of the air conditioner to shut down.

26. The control terminal according to claim 22, wherein the one or more programs, when executed by the one or more processors, further cause the one or more processors to:
generate alarm information, and controlling the air conditioner to sound an alarm; and
transmit the alarm information to a target terminal matched with the air conditioner.

27. The control terminal according to claim 22, wherein the one or more programs, when executed by the one or more processors, further cause the one or more processors to, after controlling the air conditioner to enter the high-temperature protection mode to shut down the air conditioner:
control, in response to the air conditioner being not in a cooling mode or a dehumidification mode, the air conditioner to exit the high-temperature protection mode.

28. The control terminal according to claim 22, wherein the one or more programs, when executed by the one or more processors, further cause the one or more processors to, after controlling the air conditioner to enter the high-temperature protection mode to shut down the air conditioner:
control, in response to the indoor ambient temperature being lower than a third threshold, a compressor of the air conditioner to start and the air conditioner to exit the high-temperature protection mode, the third threshold being higher than the first threshold and lower than the second threshold.

29. The control terminal according to claim 22, wherein the one or more programs, when executed by the one or more processors, further cause the one or more processors to:
obtain a current operation mode of the air conditioner; and
control, in response to the current operation mode being a cooling mode or a dehumidification mode and the indoor ambient temperature being lower than the first threshold, the air conditioner to enter the high-temperature protection monitoring mode.

30. The control terminal according to claim 22, wherein the one or more programs, when executed by the one or more processors, further cause the one or more processors to:
generate, in response to the air conditioner entering the high-temperature protection mode, tailpipe disengagement information;
perform at least one of:
transmitting the tailpipe disengagement information to a target terminal matched with the air conditioner; or
controlling the air conditioner to display the tailpipe disengagement information.

31. An air conditioner comprising:
a control apparatus including:
one or more memories storing one or more computer programs; and
one or more processors configured to execute the one or more computer programs to:
control, in response to an indoor ambient temperature being lower than a first threshold, an air conditioner to enter a high-temperature protection monitoring mode; and
control, in response to the air conditioner being in the high-temperature protection monitoring mode and the indoor ambient temperature being higher than a second threshold, the air conditioner to enter a high-temperature protection mode, to shut down the air conditioner;
wherein the second threshold is higher than the first threshold.
